(19) United States
(12) Patent Application Publication
(10) Pub. No.: US 2014/0111653 A1
(43) Pub. Date: Apr. 24, 2014

(54) METHOD AND SYSTEM FOR THE TRACKING OF A MOVING OBJECT BY A TRACKING DEVICE

(71) Applicant: Eric Willemenot De Nanc, Plouzane (FR)

(72) Inventor: Eric Willemenot De Nanc, Plouzane (FR)

(73) Assignee: MOVEE'N SEE, Plouzane (FR)

(21) Appl. No.: 14/122,805

(22) PCT Filed: May 20, 2012
(86) PCT No.: PCT/FR2012/051140

§ 371 Date: Nov. 27, 2013

(30) Foreign Application Priority Data
May 27, 2011 (FR) 11 01645

(51) Int. Cl. G01S 3/786; H04N 5/232

(52) U.S. Cl. CPC G01S 3/7864; H04N 5/23296
USPC 348/169

(57) ABSTRACT

A method for tracking a moving object by a tracking device comprises the following steps: (a) reception by the tracking device of a signal transmitted by the moving object or objects and comprising a first item of information of the position of the moving object determined from information received from a satellite positioning system, (b) determination of a second item of information of the relative altitude of the moving object with respect to the tracking device, and the said second item of information is calculated on the basis of the atmospheric pressures measured at the altitude of the tracking device and on the moving object, (c) calculation of the relative position of the moving object with respect to the tracking means, from the first and second items of information using a data fusion technique, (d) orientation of the tracking means towards the relative position calculated in step (c).

### CROSS-REFERENCE TO RELATED U.S. APPLICATIONS

Not applicable.

### STATEMENT REGARDING FEDERALLY SPONSORED RESEARCH OR DEVELOPMENT

Not applicable.

### NAMES OF PARTIES TO A JOINT RESEARCH AGREEMENT

Not applicable.

### REFERENCE TO AN APPENDIX SUBMITTED ON COMPACT DISC

Not applicable.

### BACKGROUND OF THE INVENTION

1. Field of the Invention

The present invention relates to methods and systems allowing the tracking of a cooperative moving object by a tracking device, notably comprising a video camera.

The present invention applies notably, but not exclusively, to the tracking of cooperative targets, such as sportspersons in motion, in such a way that the latter can view their physical and technical performances.

More particularly, it relates to a method for the tracking of at least one moving object by a tracking device, the tracking device comprising at least one tracking means, such as a video camera, mounted in an articulated manner on an easily transportable, fixed or mobile support.

2. Description of Related Art Including Information Disclosed Under 37 CFR 1.97 and 37 CFR 1.98

Systems for automatically tracking moving objects by video cameras are known in the prior art. Notably, systems are known having an automatically orientable line of sight in order that the latter may track the moving object, or also video systems comprising automatically adjusted zoom and/or focus as a function of information gathered by the system.

The document US2007/0133979 describes such a system in which transmitters disposed on the objects to be tracked communicate with a receiver connected to the video camera and transmit information making it possible to orient the video camera automatically on the basis of the intensity of the signal received by directive antennas. However, antennas of this type have the disadvantage of being bulky and costly for accurately tracking moving objects from a great distance.

The document US2010/0208941 also describes a system in which transmitters disposed on the objects to be tracked communicate with a receiver connected to the video camera. In this system, the calculation of the angle of inclination of the video camera is based on satellite positioning information and/or on radar positioning information. Altimetric positioning accuracy by satellite is known to be worse than the estimation of latitude or of longitude. This accuracy is typically of the order to 100 m whilst the accuracy of the longitude or of the latitude is of the order of 10 m. Moreover, when the moving object and the system are close to the ground, radar is particularly disturbed, in its estimation of the angle of inclination, by reflections of the signal on the ground and by refraction in the layer of air when the latter exhibits a temperature gradient.

In fact, it is known that a signal reflected on the ground or refracted by the layer of air does not have the same direction of arrival as the direct signal, which can intertere with the determination of the direction of arrival of the direct signal. False radar signals created by these phenomena are referred to as “phantoms” and they are sometimes difficult to identify and eliminate. When they can be identified and eliminated, it is at the cost of extremely sophisticated algorithms, which are expensive to run in real time. The system of the prior art has the major disadvantage of a complex and inefficient determination of the angle of inclination.

In the prior art, tracking a moving object can also be carried out by means of automatic analysis of the images in order to adjust the orientation of the video camera. The tracking can also be carried out by means of the disposition of infra-red transmitters located on the object, or again by means of presence detectors located in the ground. These three methods can be combined in order to give the systems the information necessary for orienting the line of sight of the video camera and possibly the adjustment of its zoom. However, these systems are costly, relatively complex to implement and have a limited range, making the tracking from a great distance of an object that is hardly recognizable in the image impossible.

In sports clubs having few financial means and not able to invest in the existing complex and too expensive technical systems, recording the performances of sportspersons is carried out either by leaving the video camera in a fixed setting without the possibility of stopping filming or of orienting and zooming in order to observe the sportsperson correctly over a complete course, or by filming the sportsperson with the help of a person who must operate the video camera. However, in practice, an instructor cannot simultaneously film the sportspersons and attend to safety and teaching. It is therefore necessary to call upon a third person, which represents an additional cost which is rarely possible for a sports club. Moreover, the intervention of an additional person filming the sportspersons, results in tracking choices that are different from those that the instructor would have desired.

The purpose of the present invention is to alleviate these disadvantages and to propose a system making it possible to track a moving object, indoors or outdoors, at a short distance or at a long distance, in a robust manner with high performance and low cost, and which is notably suitable for sports instruction applications.

### SUMMARY OF THE INVENTION

For this purpose, the tracking method is characterized in that it comprises at least the following steps:
(a) reception by the tracking device of a signal transmitted by the moving object or objects and comprising a first item of information of the position of the moving object or objects determined from information received from a satellite positioning system, (b) determination a second item of information of the relative altitude of the moving object or objects with respect to the tracking device, and the said second item of information is calculated on the basis of the atmospheric pressures measured at the altitude of the tracking device and on the moving object or objects, (c) calculation of the relative position of the moving object or objects with respect to the tracking means, from the first and second items of information using a data fusion technique, (d) orientation of the tracking means towards the relative position calculated in step (c).

Due to these arrangements, the items of information regarding the position of the moving object to be tracked are optimized and obtained by a simple and robust system, without necessitating the use of costly and/or bulky equipment as is the case for the systems of the prior art.

The determination of the relative altitude of a moving object with respect to the tracking means by means of atmospheric pressure measurements constitutes a particularly advantageous means for such a system, since the sought accuracy of a few metres is exactly that achieved by sensors that are very inexpensive (a few euros), very small (a few cubic millimetres) and very simple to implement on an entirely standard electronic board. Thus there is avoided the disadvantages of bulky radar antennas which are expensive and require complex signal processing, the disadvantages of the altitude delivered by satellite positioning systems whose accuracy is inadequate for framing a sportsperson to within a few metres in order to be able to zoom without losing the image, the disadvantages of image processing techniques where it can be very complex or even impossible to recognize the sportsperson to be filmed when that sportsperson is enclosed in a crowd or in a complex landscape, the disadvantages of the limited range of certain systems since in this case the pressure can be transmitted by radio at distances of the order of a kilometre by radio systems.

According to other features:
the method also comprises a step (e) of determination of a third item of information of position of the tracking device (12) from information received from a satellite positioning system;
the method also comprises a step (f) of determination of a fourth item of information of the distance between the moving object or objects and the tracking device;
the method also comprises a step (g) of determination of a fifth item of information of the angle of arrival of the signal in a horizontal plane; such an item of information can be delivered by antennas sensitive to the direction of arrival of the signal. When the moving object is a short distance away, typically less than 50 m, this item of information can be more reliable than that delivered by the satellite positioning system for aiming the tracking device towards the moving object. For example an error of 5° in the horizontal direction of arrival of the signal coming from a moving object situated at 30 m from the tracking device corresponds to an error of 2.6 m in the position of the moving object, whilst the information given by the satellite positioning system can have an error of the order of 10 m;
the method comprises in step (c) the third and/or the fourth, and/or the fifth item of information;
the calculation of the relative position of the moving object or objects takes into account a behavioural model of the moving object or objects by adding information on the nature of the movements into the said calculation. The expression “nature of the movement” is understood to mean for example a speed and/or a limited acceleration, and/or a minimum radius of gyration, and/or any other hypothesis;
at least one from among the first, second, third, fourth and fifth items of information furthermore comprises associated error estimations;
the second item of information relating to the altitude is calculated from the estimation of the angle of arrival in a vertical plane. Such an item of information can be delivered by antennas sensitive to the direction of arrival of the signal. This item of information can be more accurate than that delivered by a satellite positioning system. For example an error of 10° in the vertical direction of arrival of the signal from a moving object situated at 30 m from the tracking device corresponds to an altitude error of 5.2 m, whilst the altitude error in the item of information delivered by a satellite positioning system can be of the order to 100 m.
the tracking device comprises a tracking means comprising means of adjusting the filming by the tracking means, such as adjusting a zoom and/or a focus or an aperture angle, characterized in that the method furthermore comprises a step of controlling the adjustment means as a function of the distance of the moving object or objects with respect to the tracking means;
the tracking device comprises a tracking means comprising means of adjusting the filming by the tracking means, such as adjusting a zoom and/or a focus or an aperture angle, characterized in that it comprises a step of controlling the adjustment means as a function of the uncertainty of the relative position of the moving object or objects with respect to the tracking means;
the method also comprises a step (h) of reception by the tracking device of a request to track the moving object or objects, then a step (i) of transmission of a tracking signal attesting the tracking of the said moving object from the tracking device;
the method comprises at least two moving objects and a step (j) of reception of a signal transmitted from one of the moving objects indicating the moving object to be tracked, then a step (k) of sending a tracking signal attesting the tracking of the said moving object to be tracked from the tracking device;
the method comprises a prior step of calibration of the tracking device in order to know the orientation of a reference peculiar to the support and/or to the tracking means with respect to the local vertical, or within a local geographic reference system: the expression “local geographic reference system” refers to the reference constituted by the three axes, North, East and Vertical. The expression “local vertical” refers to the direction of gravity;
the calibration step consists in determining the orientation of a reference peculiar to the support or to the tracking means, by the intermediary, of accelerometers or inclinometers disposed on the support and determining the local vertical. In this way, the calibration step makes it possible to know the horizontality of a reference peculiar to the support and/or to the tracking means in the local geometric reference system;
the calibration step determining the orientation of a reference peculiar to the support furthermore comprises a compass which determines the North. The calibration step thus makes it possible to know completely the orientation of a reference peculiar to the support and/or to the tracking means;
if the first and third items of information cannot be defined, the calculation of the relative position of the moving object or objects with respect to the tracking means is carried out on the basis of the second, fourth and fifth items of information.

The relative altitude of the tracking device and of the moving object is obtained in a reliable and simple manner using pressure sensors. The required accuracy is that much easier to achieve when the measurement is differential, as in this case, and not absolute. Thus the subject to be filmed can be framed to within a few metres, which allows a sufficient zoom for observing the moving object very well.

The invention also relates to a tracking system for the implementation of the method for tracking a moving object described above, noteworthy in that it comprises a tracking device comprising at least one tracking means mounted in an articulated manner on a fixed support, a satellite positioning system and at least one pressure sensor on the moving object or objects, the tracking system furthermore comprising a satellite positioning system mounted on the moving object or objects, a transmitter and a receiver mounted on the moving object or objects and adapted to transmit and receive a signal to and from the tracking device.

According to other features, the system comprises a tracking device comprising at least one tracking means mounted in an articulated manner on a fixed support, a satellite positioning system and at least one set of antennas sensitive to direction, the tracking system furthermore comprising a satellite positioning system mounted on the moving object or objects, a transmitter and a receiver mounted on the moving object or objects and adapted to transmit and receive a signal to and from the tracking device.

According to other features, the tracking means is a video camera firmly mounted on a platform that is articulated on the support.

### BRIEF DESCRIPTION OF THE SEVERAL VIEWS OF THE DRAWINGS

The present invention will be better understood on reading the following detailed description, given with reference to the appended drawings in which:

FIG. 1 is a diagrammatic representation of a set of moving objects 14, one of which is tracked by the tracking device according to the invention,

FIG. 2 is a diagrammatic representation of one embodiment of the method;

FIG. 3 is a diagrammatic illustration of the components constituting a moving object 14.

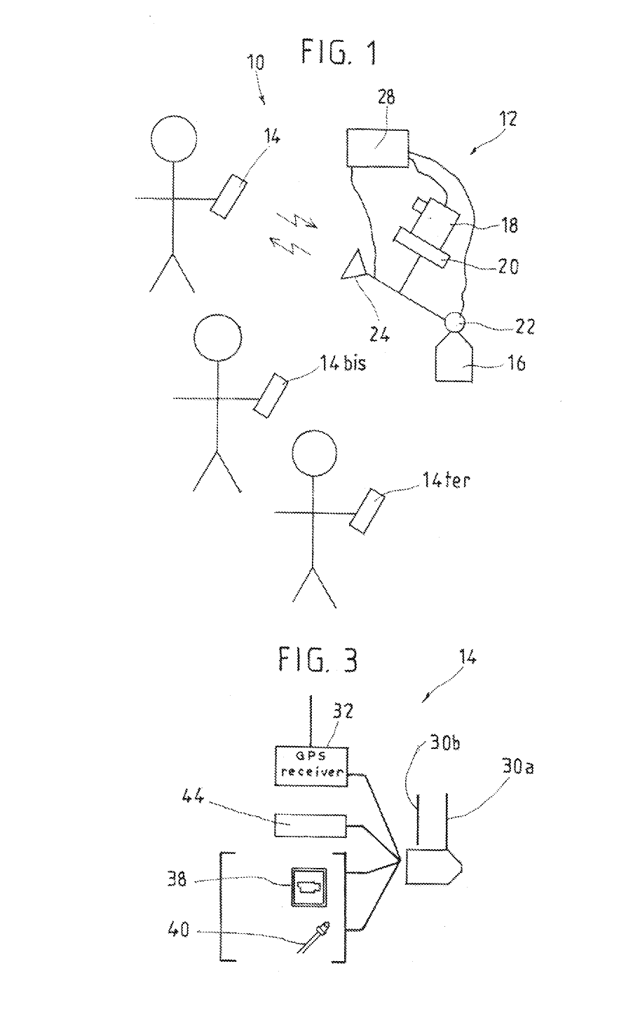

### DETAILED DESCRIPTION OF THE INVENTION

In the following description, the terms “horizontal”, “vertical”, “high” and “low” are used according to their usual meaning within the terrestrial reference system,

The teaching of certain sports benefits from video when the latter can be used easily and at affordable cost. Team sports, for example football, volleyball, etc., use video for the analysis of their play and that of their opponents. A sport like parachuting fully integrates video in the sport, using it for the analysis of performance from the very beginning. The instruction of sportspersons during their training sessions or their competitions therefore has real benefit, provided that this recording can be used simply and at affordable cost, which is not the case for all sports. In certain sports, it is a matter for example of not having to have a third person dedicated to this function. The present invention proposes a system having the advantages described above, its application to sport being only one example.

More particularly, the invention relates to a tracking system 10 notably constituted by a tracking device 12 adapted to track a moving object 14 such as a sportsperson. The tracking device 12 comprises a support 16, such as a tripod, upon which is articulated a tracking means 18, such as a video camera. The video camera 18 is connected to the support 16 by the intermediary of a platform 20 upon which, it is firmly mounted. The platform 20 is articulated on the support 16 and extends in a first plane. A set of motors 22 makes it possible to move the platform 20 with respect to the support 16. The motors 22 allow a movement of the platform 20 in rotation about a vertical axis so that the video camera 18 can be moved with a horizontal panning motion (PAN) and in rotation about a horizontal axis so that the video camera 18 can be moved with a vertical tilting motion (TILT). The servo-controlled platform 20 makes it possible to achieve all of the angular positions allowing the tracking of the moving objects 14.

The tracking device 12 is furthermore equipped with a means 24 of transmission and reception of a radio or ultrasonic signal. These means are notably constituted by a set of antennas 24 sensitive to direction, for example of the Adcock antenna type, which in a particular embodiment is mounted on the video camera 18 or on the platform 20, in order that the direction of arrival of signals from the moving object 14 is always seen at the same angle, thus reducing errors as is known in a zero-error control system. According to another embodiment, the set of antennas is mounted on the fixed support 16 in such a way that the external environment of the system is seen at constant angles in order to limit interference in the measurements. The device is furthermore provided with a satellite positioning system 26, such as a GPS. The tracking device 12 furthermore comprises a processing unit 28 which is connected to the set of antennas 24. The processing unit 28 processes the information relating to the signal received by the set of antennas 24 and the position information of the tracking device 12 coming from the satellite positioning system, as well as the controls for the motors 22, and possibly any type of interface with the tracking means 18, as well as any type of interface with the user.

The tracking system also comprises a transmitter 30a-receiver 30b assembly disposed on the moving object 14. According to a preferred variant embodiment, the system comprises several transmitter 30a-receiver 30b assemblies, each assembly being disposed on a moving object 14 to be tracked. Each moving object 14 is furthermore provided with a satellite positioning system 32, such as a GPS. The transmitter 30a-receiver 30b assemblies are adapted to communicate with the tracking device 12 and to transmit a signal containing at least an identifier specific to each moving object and a first item of position information of the moving object 14.

The position data of the tracking device 12 and the position data of the moving object 14 have errors notably due to calculation uncertainties or again to measurement tolerances of the equipment. For example, the position information gathered from a GPS position comprises the position data and an accuracy reduction coefficient making it possible to know if an evaluated GPS position is reliable or not. The method of the present invention takes account of these errors and the position of the moving object 14 and the position of the tracking device 12 will be respectively determined by a first and a third item of position information comprising the position data coming from the satellite positioning system and the associated error estimations.

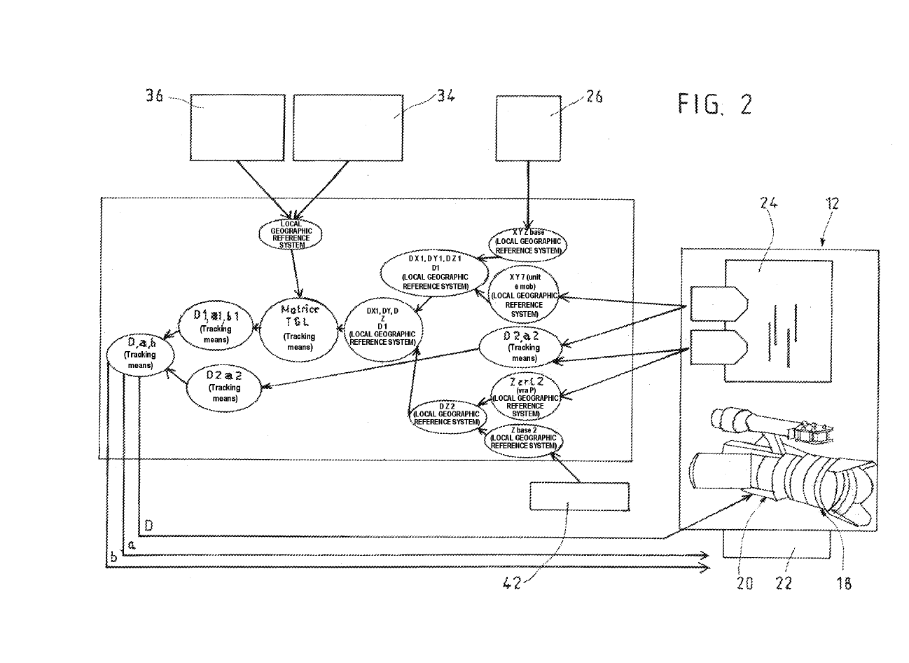

The operation of the system 10 for tracking a moving object 14 by the tracking device 12 will be described below with reference to FIG. 2.

Initially, a step of calibration of the system is carried out in order to know the position of the support in the local geographic reference system. For this purpose, in a preferred embodiment, the tracking system 10 according to the invention furthermore comprises a compass 34 and two inclinometers or accelerometers 36 providing perpendicular measurements situated on the support 16. Due to these arrangements, it is possible to determine easily the position of the support 16 in the local geographic reference system, referenced by the three axes North, East and Vertical, and then to derive, from knowledge of the state of the motors, the initial orientation of the tracking means 18 in order to be able to determine in which direction and by how much to rotate in order to aim at the moving object 14.

The items of information coming from the compass 34 and from the inclinometers 36 are taken into account when the tracking device 12 is placed on the ground and prior to any tracking of a moving object 14. The calibration step consists in determining the orientation of a first reference peculiar to the support (16) or to the tracking means (18), by the intermediary of accelerometers or of inclinometers disposed on the support or the tracking means (18) and determining the local vertical, and of a compass which determines the North. The addition of a compass 34 and of inclinometers or accelerometers 36 on the system is inexpensive, simple and reliable, and allows the portability of the system to different places without obliging the user to carry out complex operations in order to recalibrate the system.

After the calibration step, the tracking method consists in acquiring, in a synchronized or unsynchronized manner, successively or not successively, various items of information and in combining them in order to obtain, at all times an estimation of the direction and of the distance of the moving object to be tracked, and therefore various tracking instructions:
the transmitter 30a disposed on the moving object 14 transmits a signal several times per second, for example between 1 and 1000 times per second. The transmission of the signal can be carried out regularly and automatically, or it can be carried out in response to an interrogation signal, such as a request from the tracking device 12. At regular intervals, for example 1 to 100 times per second, the signal comprises the identification codes of the moving object 14 and the first item of position information of the moving object 14 in real time. The signal can moreover comprise an identification code of the tracking system 10, so that several systems can operate in the same area without interference.
the tracking device 12 determines the third item of position information by the intermediary of the data coming from the satellite positioning system 26. According to a variant embodiment, the third item of position information can have been entered manually through a user interface, or the position can come from an external unit provided with a (GPS receiver and having been placed in the immediate proximity of the tracking device 12 and adapted to communicate with it.

When the signal is received by the set of antennas 24, it is then analysed by the processing unit 28. If the processing unit 28 detects in the signal the presence of the identification code of the system and if necessary that of the moving object to be tracked, then the signal is taken into account in the updating of the estimations and the first and third items of information of the GPS position are processed by the processing unit 28. In one embodiment, the first items of position information of the moving object 14 are used for calculating, with the third items of information of the position of the tracking device 12, a first value of direction of arrival a1, b1 and a first value of distance D1 between the tracking device 12 and the moving object 14.

Moreover, the set of antennas 24 connected to the tracking means 18 is sensitive to the direction of arrival of the signal transmitted by the moving object 14. When the signal is received by the set of antennas 24 and its identification is validated, the processing unit 28 estimates at least a first angle of arrival of the signal coming from the moving object 14, in the first plane, in order to derive from it a second value of direction a2. A second item of information comprising the second direction of arrival and the associated error estimations is then determined.

According to a preferred embodiment, the system comprises two sets of antennas sensitive to direction and the second direction value is defined by a pair of angles. The angles can be determined respectively with respect to the first plane in which the platform 20 extends and with respect to a second plane perpendicular to the first plane.

According to a variant of the invention, the tracking system 10 comprises a pressure sensor 42 fixed on the tracking device 12 and a pressure sensor 44 fixed on the moving object, so that an altitude difference DZ2 can be calculated, and so that an angle of direction b can be derived by the processing unit by combination with the distance information derived from the position information, by means of the equation: angle b=arcsin (DZ2/distance)

The processing unit 28 also comprises means allowing it to estimate a second value of distance D2 of the moving object with respect to the video camera 18 on the basis of the intensity of the signal received from the moving object. According to a variant, the second distance value D2 can be estimated on the basis of the forward-and-return time of a forward-and-return signal between the tracking device 12 and the moving object. A fourth item of information comprising the second distance value D2 of the moving object 14 with respect to the tracking device 12 and the error estimations associated with its calculation is then established.

The processing unit 28 comprises calculating means adapted to calculate from the previously determined first, second, third and fourth items of information, the relative position D, a, b of the moving object. For this purpose, the calculation is carried out by means of a data fusion technique. These techniques make it possible to mix items of information coming from different sources in order to obtain an estimation and more particularly consist in integrating the multiple items of information for the purpose of reducing the uncertainty of the resultant information, as indicated in the article entitled “La fusion de données, du capteur au raisonnement (Data fusion, from sensor to reasoning)” published in the journal “Traitement du signal 1994—volume 11—n^{o}6”.

For this purpose, the calculation using the data fusion technique takes account of the reliability of the data used and the degrees of uncertainty of the input information. The fusion is based on a combination of items of information weighted by their respective uncertainties. Data fusion is a process making it possible to make the best combination, using existing and known calculation methods, of a multi-source set of data to provide a resultant item of information of better quality. It is defined that a data fusion technique consists in retaining only the data that is known to be the most accurate. For example, between the data from the precision sensor and the data from a GPS, the data from the GPS would not be taken into account in order to have better accuracy.

By way of simple example, if the measurement uncertainties in a1, a2, b1, b2, D1 and D2 are expressed in the form of respective standard deviations σₐ₁, σₐ₂, σ_{b1}, σ_{b2}, σ_{D1}, σ_{D2}, the estimations of a, b, and D can be obtained thus:

D=σ_{D2}²/(σ_{D1}²+σ_{D2}²)*D1+σ_{D1}²/(σ_{D1}²+σ_{D2}²)*D2;

a=σₐ₂²/(σₐ₁²+σₐ₂²)*a1+σₐ₁²/(σₐ₁²+σₐ₂²)*a2;

b=σ_{b2}²/(σ_{b1}²+σ_{b2}²)*b1+σ_{b1}²/(σ_{b1}²+σ_{b2}²)*b2.

For example, when the moving object is situated a long distance from the tracking device 12, a distance of more than 50 metres, the first values of direction a1, b1 and of distance D1 coming from the satellite positioning system will be given priority, because the satellite positioning error is independent of distance. On the other hand, at short range, that is to say for distances less than 50 m, the second values of distance D2 and of direction a2, b2 will be given priority, for example allocated a larger weighting factor. The weighting coefficient is defined on the basis of the error estimations and of the second distance value.

Thus, when the first and third items of information are definable, the processing unit 28 takes advantage of the redundancy between the data coming from the first and third items of information and the data coming from the second, and fourth items of information in order to optimize the calculation of the relative position D, a, b of the moving object 14, despite the errors particular to each type of calculation or of measurement.

The main purpose of using data coming from the satellite positioning system and that coming from the set of sensitive antennas 24 is to improve the aiming accuracy. In fact, the set of directive antennas 24 informs the system of its orientation with respect to the moving object but is likely to have errors of several degrees. At a distance of one hundred metres an error of 10° in the line of sight results in a deviation of about 17 metres between the moving object aimed at and the point actually at the centre of the video image. At five hundred metres, this becomes about 87 metres. Consequently, at long distances, the information coming from the satellite location data is much more pertinent than that coming from the antennas 24.

The calculating means of the processing unit 28 use known signal processing techniques which make it possible to take advantage of the redundancy of the items of information relative to direction and to distance in order to do better than can be done with each of the sources of information taken separately.

When the system is used inside a room, for example in a swimming pool in order to track and film swimmers, the first values of direction a1, b1 and of distance D1 coming from the satellite positioning systems cannot be defined. In this case, only the second and fourth items of information are used in order to determine the relative position D, a, b of the moving object 14.

According to a variant of the invention, the calculation of the relative position of the moving object with respect to the tracking means takes account of a behavioural model of the moving object; speed and acceleration are limited for example. The taking into account of this model, like other items of information, is carried out for example by Kalman filtering, in order to improve the accuracy of the calculation of the position of the moving object.

The expression “behavioural model” refers to all of the items of physical information that will be added to the measurements in the form of a mathematical model or models. For example, it will be possible to add the information that the moving object never exceeds a certain acceleration and/or a certain speed and/or a deflection angle and/or that its acceleration averaged over time is zero, etc.

The relative position of the moving object 14 is expressed with respect to the position and orientation of the video camera 18. It is then used for determining the controls or the motors 22 in order to control the movement of the platform 20 or the purpose of orienting the video camera 18 towards the moving object 14.

The video camera 18 comprises means of adjusting the filming, such as adjusting a zoom and/or a focus or an aperture angle. According to a variant embodiment, the relative position is used for controlling the adjustment means as a function of the distance of the moving object 14 with respect to the tracking means 18. Pro-vision can also be made for the method according to the invention to furthermore comprise a step of controlling the adjustment means as a function of the uncertainty of the relative position of the moving object with respect to the tracking means, in such a way as to modify the optical field of the tracking means as a function of the uncertainty. For example, this control makes it possible to widen the field when the uncertainty of the relative position is large and to reduce the field when the uncertainty of the relative position is relatively small.

The invention described above was illustrated on the basis of a tracking system comprising a tracking device 12 and one moving object 14. The invention operates similarly with several moving objects 14. In this case, it is then necessary to manage the exchanges between the tracking device 12 and the multitude of moving objects 14. The continuation of the description describes, in a non-exhaustive manner, several examples of management of exchanges between the tracking device 12 and the moving objects 14. The tracking method is in no way limited to the examples described below.

According to a first embodiment, the system comprises a main moving object 14 and secondary moving objects 14.

According to a first variant, the main moving object 14 comprises a designation means adapted to send a signal to the tracking device 12 in order to designate the moving object 14 to be tracked. This designation can be activated by a remote control function, for example by pressing a button 38. The secondary moving objects 14 do not have this operational feature. The main moving object 14 can designate itself to be tracked. When the device receives such a designation signal, it transmits a tracking signal in order to inform the moving object to be tracked and the main moving object and, if necessary, so that the transmitter 30a can transmit a signal comprising the information necessary for the implementation of the tracking method described in the first part of the description.

According to a second variant of the invention, the main moving object 14 sends a signal to the tracking device 12, indicating that the latter must automatically respond to requests from the secondary moving objects 14. Thus, when the transmitter 30a of one of the moving objects 14 sends a tracking request, the tracking device 12 receiving the signal transmits, in response, a tracking signal to the said requesting moving object 14, and the tracking method described in the first part of the description is applied to the said moving object 14.

The moving objects 14 communicate with the tracking device 12 by communication techniques known to those skilled in the art, notably by a radio or ultrasonic link. The tracking request from a secondary moving object 14 can be activated by pressing a button 38 or by voice command or by any other means.

According to a variant embodiment, the tracking of the requesting moving object 14 is carried out during a specified period of time, for example one minute. During this period of time, the possible tracking requests from the other secondary moving objects 14 are recorded without any particular action. At the end of the period of tracking a requesting moving object 14, the tracking device 12 is controlled in such a way as to monitor another moving object, preferably the one indicated by the last tracking request received.

Provision can also be made so that, in the absence of another tracking request, the moving object 14 is tracked beyond the specified time period.

Preferably, the moving objects 14 have knowledge of the information relating to their tracking, for example by the switching on or off of an LED 40 disposed on the moving object 14. The main unit can furthermore have knowledge of the tracked moving object 14.

The invention is in no way limited to the embodiments and variant embodiments described above, which have been given only by way of example. It can notably be applied to taking photographs using photographic cameras and to lighting systems that have to track a moving target in a theatrical scene.

1. Method for the tracking of at least one moving object by a tracking device, the tracking device comprising at least one tracking means mounted in an articulated manner on a fixed support, characterized in that it comprises a step of calibration of the tracking device comprising accelerometers, inclinometers or a compass, on the support or the tracking means, in order to determine the orientation of a reference peculiar to the support and/or to the tracking means with respect to the local vertical, or in the local geographic reference system and comprises at least the following steps: (a) reception by the tracking device of a signal transmitted by the moving object or objects and comprising a first item of information of the position of the moving object or objects determined from information received from a satellite positioning system,
(b) determination of a second item of information of the relative altitude of the moving object or objects with respect to the tracking device, and the said second item of information is calculated on the basis of the atmospheric pressures measured at the altitude of the tracking device and on the moving object or objects,
(c) calculation of the relative position of the moving object or objects with respect to the tracking means, from a mixture of the first and second items of information using a data fusion technique,
(d) orientation of the tracking means towards the relative position calculated in step.

2. Tracking method according to claim 1, characterized in that it also comprises a step (e) of determination of a third item of information of position of the tracking device from information received from a satellite positioning system.

3. Tracking method according to claim 1, characterized in that it also comprises a step (f) of determination of a fourth item of information of the distance between the moving object or objects and the tracking device.

4. Tracking method according to claim 1, characterized in that it also comprises a step (g) of determination of a fifth item of information of the angle of arrival of the signal in a horizontal plane.

5. Tracking method according to claim 2, characterized in that it furthermore comprises in step (c) the third and/or the fourth, and/or the fifth item of information.

6. Tracking method according to claim 1, characterized in that the calculation of the relative position of the moving object or objects takes into account a behavioural model of the moving object or objects by adding information on the nature of the movements into the said calculation.

7. Tracking method according to claim 1, characterized in that at least one from among the first, second, third, fourth and fifth items of information furthermore comprises associated error estimations.

8. (canceled)

9. Tracking method according to claim 1, the tracking device comprising a tracking means comprising means of the filming by the tracking means, such as adjusting a zoom and/or a focus or an aperture angle, characterized in that the method furthermore comprises a step of controlling the adjustment means as a function of the distance of the moving object or objects with respect to the tracking means.

10. Tracking method according to claim 1, the tracking device comprising a tracking means comprising means of adjusting the filming by the tracking means, such as adjusting a zoom and/or a focus or an aperture angle, characterized in that it comprises a step of controlling the adjustment means as a function of the uncertainty of the relative position of the moving object or objects with respect to the tracking means.

11. Tracking method according to claim 1, characterized in that it also comprises a step (h) of reception by the tracking device of a request to track the moving object or objects, then a step of transmission of a tracking signal attesting the tracking of the said moving object from the tracking device.

12. Tracking method according to claim 1, characterized in that it comprises at least two moving objects and a step (j) of reception of a signal transmitted from one of the moving objects indicating the moving object to be tracked, then a step (k) of sending a tracking signal attesting the tracking of the said moving object to be tracked from the tracking device.

14. Tracking method according to claim 12, characterized in that the calibration step comprises determining the orientation of a reference peculiar to the support or to the tracking means, by the intermediary of accelerometers or inclinometers disposed on the support and determining the local vertical.

15. Tracking method according to claim 13, characterized in that the calibration step determining the orientation of a reference peculiar to the support furthermore comprises a compass which determines the North.

16. Tracking method according claim 1, characterized in that, if the first and third items of information cannot be defined, the calculation of the relative position of the moving objector objects with respect to the tracking means is carried out on the basis of the second, fourth and fifth items of information.

17. Tracking system for the implementation of the method for tracking a moving object according to claim 1, characterized in that it comprises a tracking device comprising at least one tracking means mounted in an articulated manner on a fixed support, a satellite positioning system and at least one pressure sensor on the moving object or objects, the tracking system furthermore comprising a satellite positioning system mounted on the moving object or objects, a transmitter and a receiver mounted on the moving object or objects and adapted to transmit and receive a signal to and from the tracking device.

18. Tracking system for the implementation of the method for tracking a moving object according to claim 1, characterized in that it comprises a tracking device comprising at least one tracking means mounted in an articulated manner on a fixed support, a satellite positioning system and at least one set of antennas sensitive to direction, the tracking system furthermore comprising a satellite positioning system mounted on the moving object or object, a means for measuring atmospheric pressure on the moving object or objects, a transmitter and a receiver mounted on the moving object or objects and adapted to transmit and receive a signal to and from the tracking device.

19. Tracking system according to claim 18, characterized in that the tracking means is a video camera firmly mounted on a platform that is articulated on the support.
